(19) United States
(12) Patent Application Publication
(10) Pub. No.: US 2017/0338608 A1
(43) Pub. Date: Nov. 23, 2017

(54) MULTI-TYPE COMPATIBLE CONNECTOR

(71) Applicants: Pei-Lun WANG, Keelung City (TW); Xiangping SONG, Shenzhen (CN)

(72) Inventors: Pei-Lun WANG, Keelung City (TW); Xinping LUO, Hengnan County (CN); Chien-Wei LEE, New Taipei City (TW)

(21) Appl. No.: 15/597,849

(22) Filed: May 17, 2017

(30) Foreign Application Priority Data
May 19, 2016 (TW) 105207378

(51) Int. Cl. H01R 27/00; H01R 13/516; H01R 24/64; H01R 13/26; H01R 107/00

(52) U.S. Cl. CPC H01R 27/00; H01R 24/64; H01R 13/26; H01R 13/516; H01R 2107/00

(57) ABSTRACT

A multi-type compatible connector includes an insulated seat (100), a first terminal set (210), a second terminal set (220) and a third terminal set (230). The insulated seat (100) is extended with a first tongue (110) and a second tongue (120). The first terminal set (210) is embedded in the first tongue (110). The second terminal set (220) and the third terminal set (230) are embedded in the second tongue (120). The first terminal set (210), the second terminal set (220) and the third terminal set (230) are arranged in different types. Thereby it can be compatible with male connectors with various specifications.

### BACKGROUND OF THE INVENTION

### 1. Technical Field

The invention relates to an electric connector, particularly to a multi-type compatible connector with two tongues.

### 2. Related Art

Micro USB is a common connecting interface which is widely applied to mobile devices. The USB Type-C interface will be a new generation of connecting interface replacing Micro USB. The Lightening is a new generation of connecting interface of Apple Company. All the above three connecting interfaces can be seen in current mobile devices. However, the three cannot be compatible with each other. Users cannot use these different connectors unless they have prepared respectively corresponding cables.

### SUMMARY OF THE INVENTION

The invention provides a multi-type compatible connector which can be plugged in by male connectors with various specifications.

The invention provides a multi-type compatible connector includes an insulated seat, a first terminal set, a second terminal set and a third terminal set. The insulated seat is extended with a first tongue and a second tongue. The first terminal set is embedded in the first tongue. The second terminal set and the third terminal set are embedded in the second tongue. The first terminal set, the second terminal set and the third terminal set are arranged in different types.

In the multi-type compatible connector of the invention, the first tongue and the second tongue extend toward the same direction and are parallelly arranged at an interval.

The multi-type compatible connector of the invention further includes a metal case covering the insulated seat and surrounding the first tongue and the second tongue, wherein the metal case is formed with an opening, and both the first and second tongues extend toward the opening.

In the multi-type compatible connector of the invention, the first terminal set is exposed and arranged on two sides of the first tongue, the first terminal set comprises twelve pairs of first terminals, and the first terminals are exposed on two sides of the first tongue, an outline of the first tongue is compatible with a USB type-C specification, and the first terminals are arranged to meet the USB type-C specification.

In the multi-type compatible connector of the invention, the second terminal set comprises five second terminals exposed and arranged on a side of the second tongue, and the second terminals are arranged to meet a lightning specification.

In the multi-type compatible connector of the invention, the third terminal set comprises eight third terminals exposed and arranged on a side of the second tongue, an outline of the second tongue is compatible with a micro USB specification, and the third terminals are arranged to meet the micro USB specification.

In the multi-type compatible connector of the invention, the second terminal set and the third terminal set are exposed and arranged on the same side of the second tongue, the second tongue comprises a root portion connecting the insulated seat and an end portion extending from the root portion, the second terminal set is exposed on the root portion, the third terminal set is exposed on the end portion, and a width of the end portion is narrower than that of the root portion.

In the multi-type compatible connector of the invention, a distance between the first tongue and the second tongue is compatible with a thickness of a male connector of a standard lightening specification.

The multi-type compatible connector of the invention has the first tongue and the second tongue to dispose the first terminal set, the second terminal set and the third terminal set with different specifications, so that three connector interfaces with different specifications (USB Type-C, lightening and Micro USB) can be integrated in a single connector to be inserted by various male connectors.

### BRIEF DESCRIPTION OF THE DRAWINGS

FIG. 1 is a perspective view of the multi-type compatible connector of a preferred embodiment of the invention;

FIG. 2 is another perspective view of the multi-type compatible connector of a preferred embodiment of the invention;

FIG. 3 is a transversely cross-sectional view of the multi-type compatible connector of a preferred embodiment of the invention;

FIG. 4 is a longitudinally cross-sectional view of the multi-type compatible connector of a preferred embodiment of the invention;

FIG. 5 is a schematic view of the multi-type compatible connector of a preferred embodiment of the invention in use;

FIG. 6 is another schematic view of the multi-type compatible connector of a preferred embodiment of the invention in use; and

FIG. 7 is still another perspective view of the multi-type compatible connector of a preferred embodiment of the invention in use.

### DETAILED DESCRIPTION OF THE INVENTION

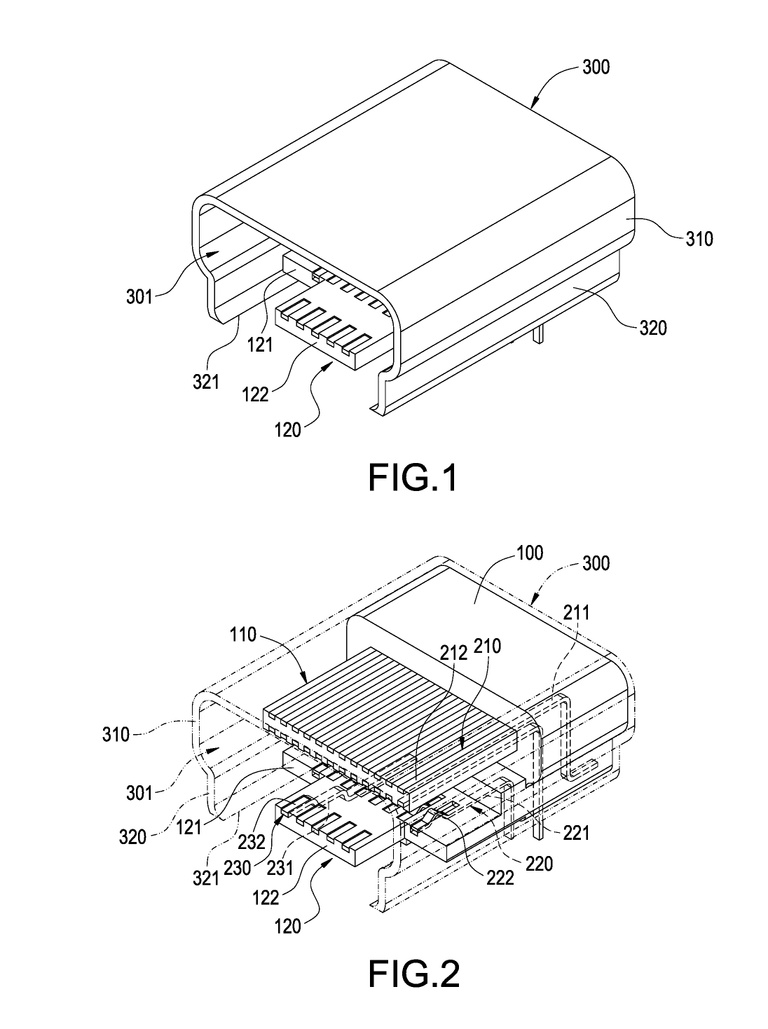

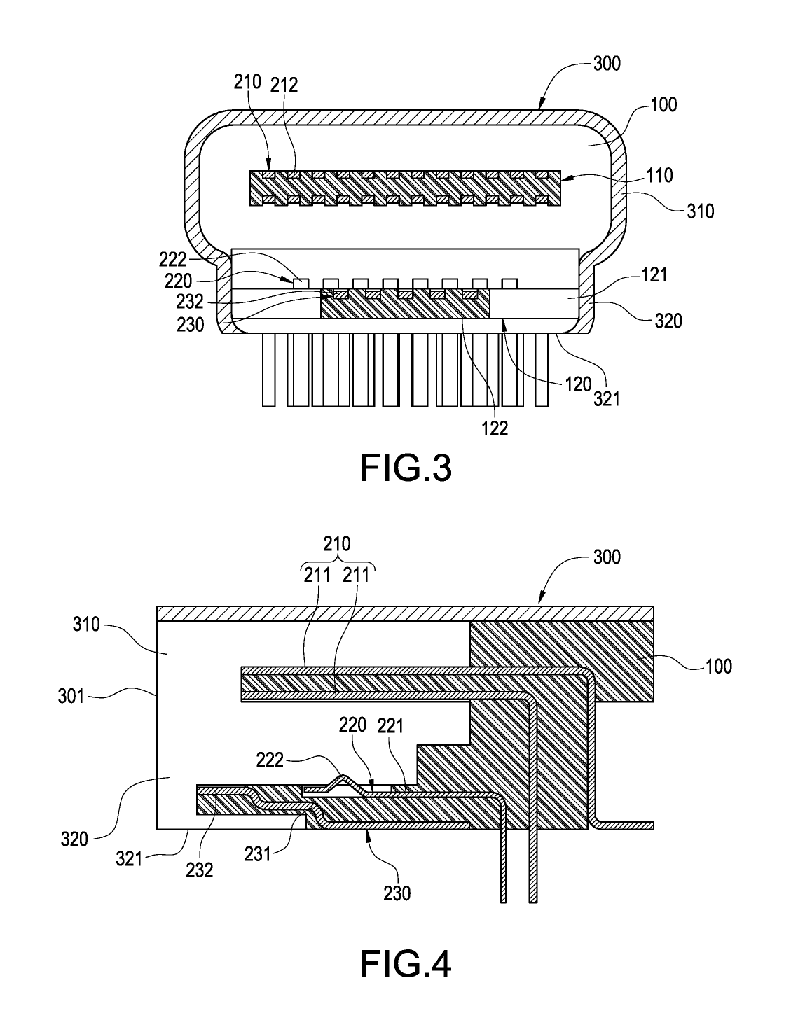

Please refer to FIGS. 1-4. A preferred embodiment of the invention provides a multi-type compatible connector. It includes an insulated seat 100, a first terminal set 210, a second terminal set 220, a third terminal set 230 and a metal case 300. The first terminal set 210, the second terminal set 220 and the third terminal set 230 are arranged in different types.

In this embodiment, preferably, the insulated seat 100 is a plastic block, and one side of the insulated seat 100 is extended with a first tongue 110 and a second tongue 120. Preferably, the first tongue 110 and the second tongue 120 extend toward the same direction. The first tongue 110 and the second tongue 120 are parallelly arranged at an interval. The outline of the first tongue 110 is compatible with the specification of USB type-C so as to be able to be connected by a general USB type-C male connector. The second tongue 120 includes a root portion 121 connecting the insulated seat 100 and an end portion 122 extending from the root portion 121. The distance between the first tongue 110 and the root portion 121 of the second tongue 120 corresponds to the thickness of a general lightening male connector so as to allow being plugged in by a general micro USB male connector. The outline of the end portion 122 of the second tongue 120 is compatible with the micro USB specification so as to be connected by a general micro USB male connector.

In this embodiment, the first terminal set 210 preferably includes twelve pairs of first terminals 211 (i.e., twenty four first terminals 211). Each of the first terminals 211 is a strip of metal sheet. The first terminal set 210 is embedded in the first tongue 110. Preferably, the first terminals 211 are embedded in the insulated seat 100. An end of each first terminal 211 extends to pass through the insulated seat 100, and the other end of the first terminal 211 extends to be in the first tongue 110 to form a first connecting portion 212. Each first connecting portion 212 is exposed on a side of the first tongue 110. Preferably, the first connecting portions 212 of the first terminals 211 are oppositely exposed on two sides of the first tongue 110. The first connecting portions 212 are arranged to meet the USB type-C specification so as to connect a USB type-C male connector.

In this embodiment, the second terminal set 220 preferably includes five second terminals 221. Each of the second terminals 221 is a strip of metal sheet. The second terminal set 220 is embedded in the second tongue 120. Preferably, the second terminals 221 are embedded in the insulated seat 100. An end of each second terminal 221 extends to pass through the insulated seat 100, and the other end of the second terminal 221 extends to be in the second tongue 120 to form a second connecting portion 222. Each second connecting portion 222 is exposed on a side of the root portion 121 of the second tongue 120. The second connecting portions 222 are arranged to meet the lightning specification so as to connect a lightning male connector.

In this embodiment, the third terminal set 230 preferably includes eight third terminals 231. Each of the third terminals 231 is a strip of metal sheet. The third terminal set 230 is embedded in the second tongue 120. Preferably, the third terminals 231 are embedded in the insulated seat 100. An end of each third terminal 231 extends to pass through the insulated seat 100, and the other end of the third terminal 231 extends to be in the second tongue 120 to form a third connecting portion 232. Each third connecting portion 232 is exposed on a side of the end portion 122 of the second tongue 120. The third connecting portions 232 are arranged to meet the micro USB specification so as to connect a micro USB male connector. The third connecting portions 232 and the second connecting portions 222 are preferably exposed on the same side of the second tongue 120.

The metal case 300 tightly covers the insulated seat 100 and surrounds the first tongue 110 and the second tongue 120. The metal case 300 is formed with an opening 301 and both the first and second tongues 110, 120 extend toward the opening 301. The metal case 30 is formed with a first portion 310 and a second portion 320 connecting the first portion 310. The second portion 320 is formed with an aperture 321. The inner contour of the first portion 310 is compatible with the outer contour of a male connector of the general USB type-C specification. The first tongue 110 is received in the first portion 310 so that the space between the first portion 310 and the first tongue 110 can be inserted by a male connector of the general USB type-C specification. The inner contour of the second portion 320 is compatible with the outer contour of a male connector of the general micro USB specification. The second tongue 120 is received in the second portion 320 and the end portion 122 of the second tongue 120 is arranged near the aperture 321 so that the space between the second portion 320 and the second tongue 120 can be inserted by a male connector of the general micro USB specification.

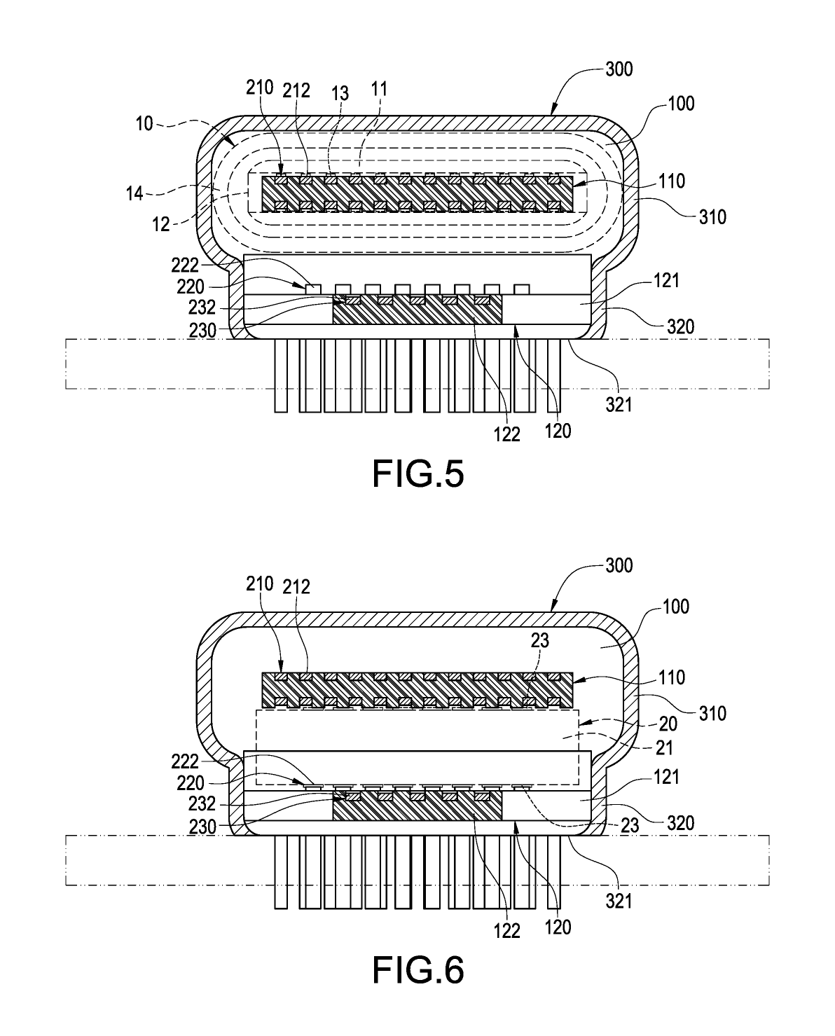

Please refer to FIGS. 5-7. The multi-type compatible connector of the invention can be connected to a first plug 10, a second plug 20 and a third connector 30 with different specifications.

Refer to FIG. 5. The first plug 10 is a male connector of the general USB type-C specification. The first plug 10 has a first connecting tongue 11. The first connecting tongue 11 is longitudinally formed with a first slot 12. Two opposite sides in the first slot 12 are provided with twelve pairs of first connecting terminals 13. The first connecting tongue 11 is covered by a first case 14 whose outer contour is compatible with the USB type-C specification.

Refer to FIGS. 2 and 5. When the first plug 10 is connected to the multi-type compatible connector of the invention, the first connecting tongue 11 passes the opening 301 of the metal case 300 to enter the space between the first portion 310 of the metal case 300 and the first tongue 110. The outer surface of the first case 14 is tightly fastened to the inner surface of the first portion 310. The first tongue 110 is inserted into the first slot 12. Each of the first connecting portions 212 of the first terminals 211 touches and electrically connects corresponding one of the first connecting terminals 13.

Refer to FIG. 6. The second plug 20 is a male connector of the general lightning specification. The second plug 20 has a second connecting tongue 21. The second connecting tongue 21 is provided with eight identical second connecting terminals 23 (sixteen second connecting terminals 23 in total).

Refer to FIGS. 2 and 6. When the second plug 20 is connected to the multi-type compatible connector of the invention, the second connecting tongue 21 passes the opening 301 of the metal case 300 to enter the space between the first tongue 110 and the root portion 121 of the second tongue 120. Each of the second connecting portions 222 of the second terminals 221 touches and electrically connects corresponding one of the second connecting terminals 23 on a side of the second tongue 21.

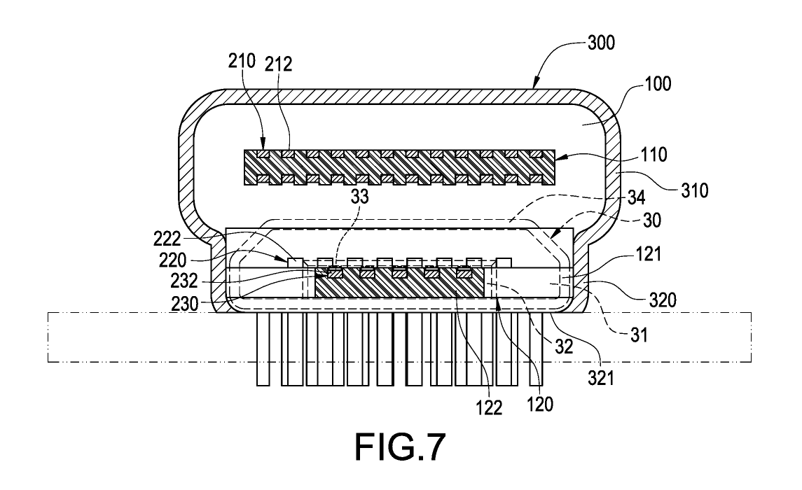

Refer to FIG. 7. The third plug 30 is a male connector of the general micro USB specification. The third plug 30 has a third connecting tongue 31. The third connecting tongue 31 is longitudinally formed with a third slot 32. A side in the third slot 32 is provided with five third connecting terminals 33. The third connecting tongue 31 is covered by a third case 34 whose outer contour is compatible with the micro USB specification.

Refer to FIGS. 2 and 7. When the third plug 30 is connected to the multi-type compatible connector of the invention, the third connecting tongue 31 passes the opening 301 of the metal case 300 to enter the space between the second portion 320 of the metal case 300 and the second tongue 120. The aperture 321 in the second portion 320 of the metal case 300 allows the third case 34 to pass to be connected. The outer surface of the third case 34 is tightly fastened to the inner surface of the second portion 320. The end portion 122 of the second tongue 120 is inserted into the third slot 32. Each of the third connecting portions 232 of the third terminals 231 touches and electrically connects corresponding one of the third connecting terminals 33.

The multi-type compatible connector of the invention has the first tongue 110 and the second tongue 120 to dispose the first terminal set 210, the second terminal set 220 and the third terminal set 230 with different specifications, so that three connector interfaces with different specifications (USB Type-C, lightening and Micro USB) can be integrated in a single connector to be inserted by various male connectors.

It will be appreciated by persons skilled in the art that the above embodiment has been described by way of example only and not in any limitative sense, and that various alterations and modifications are possible without departure from the scope of the invention as defined by the appended claims.

What is claimed is:

1. A multi-type compatible connector comprising an insulated seat (100), a first terminal set (210), a second terminal set (220) and a third terminal set (230), wherein the insulated seat (100) is extended with a first tongue (110) and a second tongue (120), the first terminal set (210) is embedded in the first tongue (110), the second terminal set (220) and the third terminal set (230) are embedded in the second tongue (120), and the first terminal set (210), the second terminal set (220) and the third terminal set (230) are arranged in different types.

2. The multi-type compatible connector of claim 1, wherein the first tongue (110) and the second tongue (120) extend toward the same direction and are parallelly arranged at an interval.

3. The multi-type compatible connector of claim 1, further comprising a metal case (300) covering the insulated seat (100) and surrounding the first tongue (110) and the second tongue (120), wherein the metal case (300) is formed with an opening (301), and both the first and second tongues (110, 120) extend toward the opening (301).

4. The multi-type compatible connector of claim 3, wherein the metal case (300) is formed with an aperture (321), and the second tongue (120) is arranged near the aperture (321).

5. The multi-type compatible connector of claim 1, wherein the first terminal set (210) is exposed and arranged on two sides of the first tongue (110).

6. The multi-type compatible connector of claim 5, wherein the first terminal set (210) comprises twelve pairs of first terminals (211), and the first terminals (211) are exposed on two sides of the first tongue (110).

7. The multi-type compatible connector of claim 6, wherein an outline of the first tongue (110) is compatible with a USB type-C specification, and the first terminals (211) are arranged to meet the USB type-C specification.

8. The multi-type compatible connector of claim 1, wherein the second terminal set (220) comprises five second terminals (221) exposed and arranged on a side of the second tongue (120).

9. The multi-type compatible connector of claim 8, wherein the second terminals (221) are arranged to meet a lightning specification.

10. The multi-type compatible connector of claim 1, wherein the third terminal set (230) comprises eight third terminals (231) exposed and arranged on a side of the second tongue (120).

11. The multi-type compatible connector of claim 10, wherein an outline of the second tongue (120) is compatible with a micro USB specification, and the third terminals (231) are arranged to meet the micro USB specification.

12. The multi-type compatible connector of claim 1, wherein the second terminal set (220) and the third terminal set (230) are exposed and arranged on the same side of the second tongue (120).

13. The multi-type compatible connector of claim 12, wherein the second tongue (120) comprises a root portion (121) connecting the insulated seat (100) and an end portion (122) extending from the root portion (121), the second terminal set (220) is exposed on the root portion (121), and the third terminal set (230) is exposed on the end portion (122).

14. The multi-type compatible connector of claim 13, wherein a width of the end portion (122) is narrower than that of the root portion (121).

15. The multi-type compatible connector of claim 1, wherein a distance between the first tongue (110) and the second tongue (120) is compatible with a thickness of a male connector of a standard lightening specification.
